(19) United States
(12) Patent Application Publication
(10) Pub. No.: US 2023/0219576 A1
(43) Pub. Date: Jul. 13, 2023

(54) TARGET SLIP ESTIMATION

(71) Applicant: GM Global Technology Operations LLC, Detroit, MI (US)

(72) Inventors: Joonho Lee, Troy, MI (US); Chelsea Gardner, Holly, MI (US); Josh Campbell, Royal Oak, MI (US); Danny John Grignion, Belle River (CA); Ryan C. Morris, Farmington Hills, MI (US); Jason Seunghwa Rhee, Canton, MI (US); Jackie Chan, Honolulu, HI (US)

(21) Appl. No.: 17/575,131

(22) Filed: Jan. 13, 2022

(51) Int. Cl. B60W 40/064; B60W 30/02; B60W 50/00; B60T 8/176; B60W 40/068; G06N 20/00

(52) U.S. Cl. CPC B60W 40/064; B60T 8/176; B60W 30/02; B60W 40/068; B60W 50/0098; G06N 20/00; B60T 8/175; B60W 2050/0026; B60W 2520/26; B60W 2520/28; B60W 2552/15; B60W 2552/35

(57) ABSTRACT

A system comprises a computer including a processor and a memory. The memory includes instructions such that the processor is programmed to: predict, at a trained machine learning classifier, a target slip value based on a predicted slip slope and a predicted road texture, wherein the predicted slip slope and the predicted road texture are determined using sensor data representing tire forces and modify at least one vehicle action based on the target slip value when a confidence level value corresponding to the target slip value is greater than or equal to a confidence level threshold.

### INTRODUCTION

The present disclosure relates to estimating target slip using a machine learning classifier as well as interpolation when a confidence level value is less than a confidence level threshold.

Tire force values are estimated because actual tire forces are typically not known. One tire force that can be estimated is target slip or target grip. The estimated target slip can be used for vehicle stability control. However, conventional target slip estimation techniques do not account for dynamically changing driving conditions, such as a typical classifier provides predetermined values as well as with the low confidence level value the classifier cannot determine target slip value.

### SUMMARY

A system comprises a computer including a processor and a memory. The memory includes instructions such that the processor is programmed to: predict, at a trained machine learning classifier, a target slip value based on a predicted slip slope and a predicted road texture, wherein the predicted slip slope and the predicted road texture are determined using sensor data representing tire forces and modify at least one vehicle action based on the target slip value when a confidence level value corresponding to the target slip value is greater than or equal to a confidence level threshold.

In other features, the processor is further programmed to determine the target slip value via interpolation modeling when the confidence level value is less than the confidence level threshold.

In other features, the interpolation modeling comprises linear interpolation modeling.

In other features, the processor is further programmed to receive the sensor data representing the tire forces.

In other features, the tire forces comprise measurements representing a wheel velocity of a vehicle.

In other features, the trained machine learning classifier comprises a Gaussian Process Classifier.

In other features, the processor is further programmed to modify at least one of anti-lock braking system, a traction control system, or an electronic stability control system based on the target slip value.

In other features, the processor is further programmed to determine the predicted road texture based on at least one of a slip ratio or the tire forces.

In other features, the processor is further programmed to access a lookup table that relates road texture to the at least one of the slip ratio or the tire forces.

In other features, the trained machine learning classifier generates the confidence level value.

A method includes predicting, at a trained machine learning classifier, a target slip value based on a predicted slip slope and a predicted road texture, wherein the predicted slip slope and the predicted road texture are determined using sensor data representing tire forces and modifying at least one vehicle action based on the target slip value when a confidence level value corresponding to the target slip value is greater than or equal to a confidence level threshold.

In other features, the method further includes determining the target slip value via interpolation modeling when the confidence level value is less than the confidence level threshold.

In other features, the interpolation modeling comprises linear interpolation modeling.

In other features, the method further includes receiving the sensor data representing the tire forces.

In other features, the tire forces comprise measurements representing a wheel velocity of a vehicle.

In other features, the trained machine learning classifier comprises a Gaussian Process Classifier.

In other features, the method further includes modifying at least one of anti-lock braking system, a traction control system, or an electronic stability control system based on the target slip value.

In other features, the method further includes determining the predicted road texture based on at least one of a slip ratio or the tire forces.

In other features, the method further includes accessing a lookup table that relates road texture to the at least one of the slip ratio or the tire forces.

In other features, the trained machine learning classifier generates the confidence level value.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a block diagram of an example system including a vehicle;

FIG. 2 is a block diagram of an example vehicle computer;

FIG. 3 is a block diagram of an example computing device;

FIG. 4 is a graph representing road texture as a function of slip slope; and

FIG. 5 is a flow diagram illustrating an example process for estimating a target slip and controlling at least one vehicle action based on the estimated target slip.

### DETAILED DESCRIPTION

The following description is merely exemplary in nature and is not intended to limit the present disclosure, application, or uses.

Target slip can be defined as the relative motion between a tire, such as a vehicle tire, and a road surface the tire is moving on. In some examples, target slip can be generated by the tire’s rotation speed being greater than or less than the free-rolling speed. As discussed herein, target slips relevant to maximum tire grip can be estimated based on tire forces measured by one or more vehicle sensors, which can be used to estimate road surface types. One or more vehicle components can adjust a vehicle action to maximize tire grip based on the target slip.

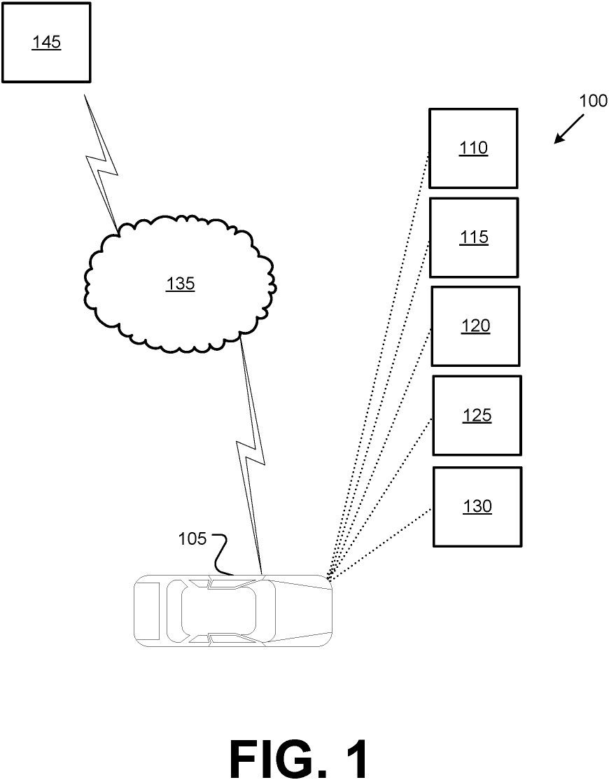

FIG. 1 is a block diagram of an example vehicle system 100. The system 100 includes a vehicle 105, which can comprise a land vehicle such as a car, truck, etc., an aerial vehicle, and/or an aquatic vehicle. The vehicle 105 includes a computer 110, vehicle sensors 115, actuators 120 to actuate various vehicle components 125, and a vehicle communications module 130. Via a network 135, the communications module 130 allows the computer 110 to communicate with a server 145.

The computer 110 may operate a vehicle 105 in an autonomous, a semi-autonomous mode, or a non-autonomous (manual) mode. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via the vehicle 105 communications module 130 as described further below, more than one processor, e.g., included in electronic controller units (ECUs) or the like included in the vehicle 105 for monitoring and/or controlling various vehicle components 125, e.g., a powertrain controller, a brake controller, a steering controller, etc. Further, the computer 110 may communicate, via the vehicle 105 communications module 130, with a navigation system that uses the Global Position System (GPS). As an example, the computer 110 may request and receive location data of the vehicle 105. The location data may be in a known form, e.g., geo-coordinates (latitudinal and longitudinal coordinates).

The computer 110 is generally arranged for communications on the vehicle 105 communications module 130 and also with a vehicle 105 internal wired and/or wireless network, e.g., a bus or the like in the vehicle 105 such as a controller area network (CAN) or the like, and/or other wired and/or wireless mechanisms.

Via the vehicle 105 communications network, the computer 110 may transmit messages to various devices in the vehicle 105 and/or receive messages from the various devices, e.g., vehicle sensors 115, actuators 120, vehicle components 125, a human machine interface (HMI), etc. Alternatively or additionally, in cases where the computer 110 actually comprises a plurality of devices, the vehicle 105 communications network may be used for communications between devices represented as the computer 110 in this disclosure. Further, as mentioned below, various controllers and/or vehicle sensors 115 may provide data to the computer 110. The vehicle 105 communications network can include one or more gateway modules that provide interoperability between various networks and devices within the vehicle 105, such as protocol translators, impedance matchers, rate converters, and the like.

Vehicle sensors 115 may include a variety of devices such as are known to provide data to the computer 110. For example, the vehicle sensors 115 may include wheel sensors that measure tire forces. The vehicle sensors 115 may also include Light Detection and Ranging (lidar) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects, etc., relative to the location of the vehicle 105. The vehicle sensors 115 may further include camera sensor(s) 115, e.g., front view, side view, rear view, etc., providing images from a field of view inside and/or outside the vehicle 105.

The vehicle 105 actuators 120 are implemented via circuits, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation-such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a park assist component, an adaptive cruise control component, an adaptive steering component, a movable seat, an anti-lock braking system component (ABS), a traction control system component (TCS), and/or an electronic stability control system component.

In addition, the computer 110 may be configured for communicating via a vehicle-to-vehicle communication module or interface 130 with devices outside of the vehicle 105, e.g., through a vehicle to vehicle (V2V) or vehicle-to-infrastructure (V2X) wireless communications to another vehicle, to (typically via the network 135) a remote server 145. The module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth®, IEEE 802.11, dedicated short-range communications (DSRC), and/or wide area networks (WAN), including the Internet, providing data communication services.

The network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services.

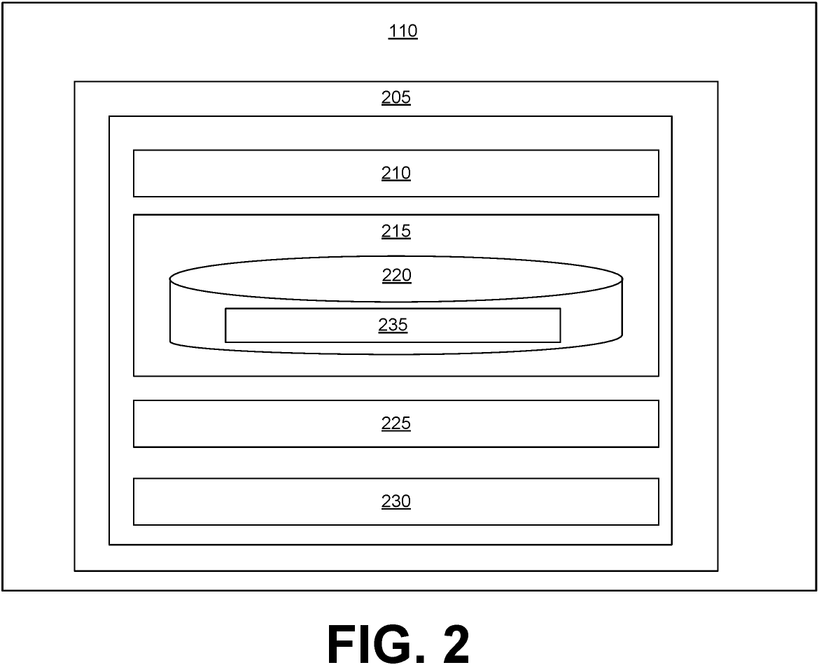

FIG. 2 illustrates an example computer 110 that includes a tire slip classification system 205. As shown, the tire slip classification system 205 includes a classifier module 210, a storage module 215 that includes database 220, an observer module 225, and an interpolation module 230. The classifier module 210 can manage, maintain, train, implement, utilize, or communicate with one or more machine learning classifiers. For example, the classifier module 210 can communicate with the storage module 215 to access a machine learning classifier 235 stored within the database 220.

The machine learning classifier 235 can be trained at the server 145 and provided to the computer 110 via the network 130. In an example implementation, the machine learning classifier 235 comprises probabilistic supervised machine learning framework, such as a Gaussian Process Classifier, that generates predictions and provides uncertainty measures corresponding to the predictions, i.e., confidence level values. The generated predictions can incorporate prior knowledge, i.e., kernels, by using one or more suitable functions, such as a squared exponential (SE) kernel function.

The kernels can be optimized using hyperparameter optimization. In one or more implementations, hyperparameters for the kernel(s) can include covariance characteristics, signal standard deviation, and/or noise standard deviation.

During operation, the machine learning classifier 235 receives data from the sensors 115 and/or observer module 225, as described in greater detail below, and generates a prediction representing the target slip value along with corresponding confidence level values. If the confidence level value is less than a confidence level threshold, the linear interpolation module 230 determines the target slip value based on a predicted slip slope and a predicted road texture. Otherwise, the target slip value prediction generated by the machine learning classifier 235 can be used to control one or more vehicle actions via the actuators 120 and/or the components 125.

The observer module 225 can comprise an estimator that estimates a slip slope based on one or more acceleration values associated with a wheel of the vehicle 105. The acceleration values can be measured using one or more vehicle sensors 115. Using the measured acceleration values, the observer module 225 can estimate a slip slope according to equation 1:

$$s l i p s l o p e = \frac{\partial \left({F}_{x x} \left(\text{λ}\right) + σ \left(t\right)\right)}{\partial \text{λ}}$$

where slip slope comprises the estimated slip slope, Fₓₓ comprises measured tire forces, σ(t) comprises measured forces unrelated to measured tire forces, and λ comprises a slip ratio. The measured tire forces can include, but are not limited to, rear wheel axle velocity as measured by the sensors 115.

Further, the observer module 225 can also predict a road texture. For example, the observer module 225 can predict the road texture based on the slip ratio and/or the measured tire forces. Road texture can include, but is not limited to, snow/ice covered road texture, gravel road texture, and/or asphalt road texture. In an example implementation, the observer module 225 can include a lookup table that relates slip ratio and/or measured tire forces to road texture.

The interpolation module 230 uses one or more suitable linear interpolation processes to predict, i.e., estimate, the target slip value. For example, the interpolation module 230 can receive input representing the predicted slip slope and the predicted road texture from the observer module 225. The interpolation module 230 may conduct suitable curve-fitting processes to predict the target slip value.

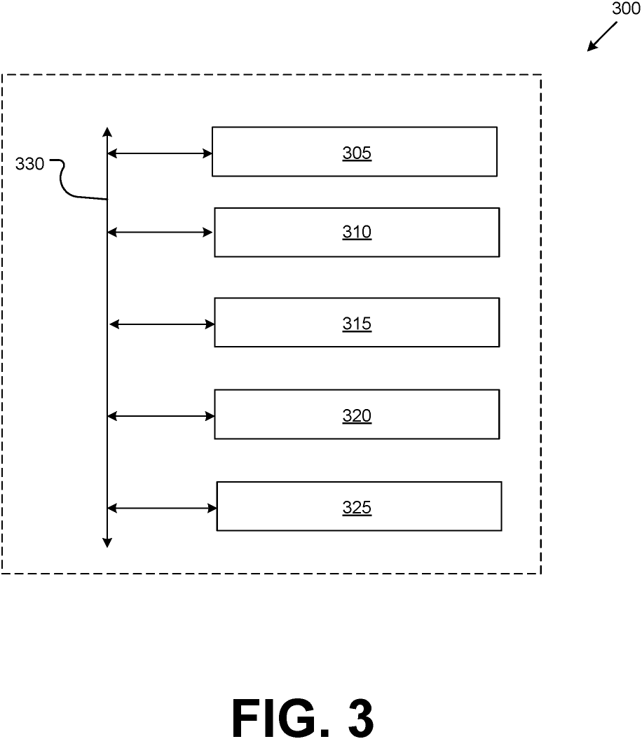

FIG. 3 illustrates an example computing device 300 i.e., computer 110 and/or server(s)145 that may be configured to perform one or more of the processes described herein. As shown, the computing device can comprise a processor 305, memory 310, a storage device 315, an I/O interface 320, and a communication interface 325. Furthermore, the computing device 300 can include an input device such as a touchscreen, mouse, keyboard, etc. In certain implementations, the computing device 300 can include fewer or more components than those shown in FIG. 3.

In particular implementations, processor(s) 305 includes hardware for executing instructions, such as those making up a computer program. As an example, and not by way of limitation, to execute instructions, processor(s) 305 may retrieve (or fetch) the instructions from an internal register, an internal cache, memory 310, or a storage device 315 and decode and execute them.

The computing device 300 includes memory 310, which is coupled to the processor(s) 305. The memory 310 may be used for storing data, metadata, and programs for execution by the processor(s). The memory 310 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 310 may be internal or distributed memory.

The computing device 300 includes a storage device 315 includes storage for storing data or instructions. As an example, and not by way of limitation, storage device 315 can comprise a non-transitory storage medium described above. The storage device 315 may include a hard disk drive (HDD), flash memory, a Universal Serial Bus (USB) drive or a combination of these or other storage devices.

The computing device 300 also includes one or more input or output (“I/O”) devices/interfaces 320, which are provided to allow a user to provide input to (such as user strokes), receive output from, and otherwise transfer data to and from the computing device 300. These I/O devices/interfaces 320 may include a mouse, keypad or a keyboard, a touch screen, camera, optical scanner, network interface, modem, other known I/O devices or a combination of such I/O devices/interfaces 320. The touch screen may be activated with a writing device or a finger.

The I/O devices/interfaces 320 may include one or more devices for presenting output to a user, including, but not limited to, a graphics engine, a display (e.g., a display screen), one or more output drivers (e.g., display drivers), one or more audio speakers, and one or more audio drivers. In certain implementations, devices/interfaces 320 is configured to provide graphical data to a display for presentation to a user. The graphical data may be representative of one or more graphical user interfaces and/or any other graphical content as may serve a particular implementation.

The computing device 300 can further include a communication interface 325. The communication interface 325 can include hardware, software, or both. The communication interface 325 can provide one or more interfaces for communication (such as, for example, packet-based communication) between the computing device and one or more other computing devices 300 or one or more networks. As an example, and not by way of limitation, communication interface 325 may include a network interface controller (NIC) or network adapter for communicating with an Ethernet or other wire-based network or a wireless NIC (WNIC) or wireless adapter for communicating with a wireless network, such as a WI-FI. The computing device 300 can further include a bus 330. The bus 330 can comprise hardware, software, or both that couples components of computing device 300 to each other.

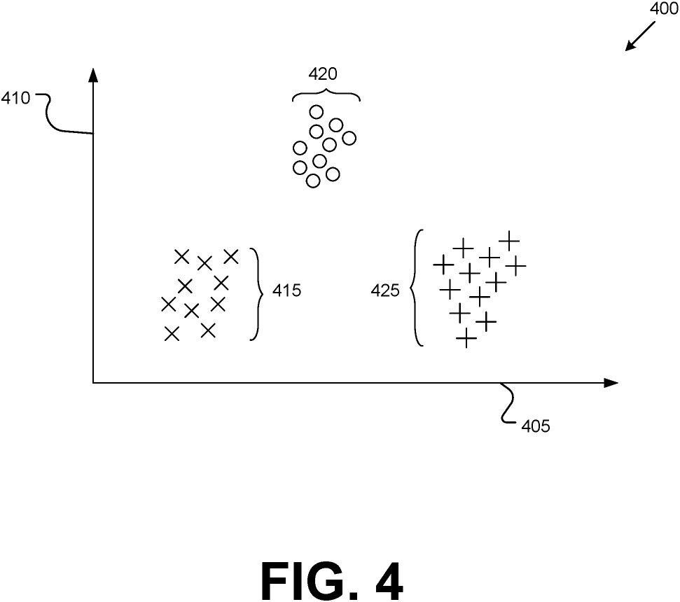

FIG. 4 illustrates an example graph 400 of relevant slip slope 405 to corresponding road type 410. As shown, the road surface types 410 can include, but are not limited to, slip slope values corresponding to snow/ice covered road surface types 415, gravel road surface types 420, and/or asphalt road surface types 425. The graph 400 is representative of an interpolation for determining a target slip estimate when the machine learning classifier 235 generates a target slip estimate having low confidence level value, i.e., less than a confidence level threshold, which is discussed in greater detail below. The computer 110 can use one or more suitable linear interpolation modeling processes to determine suitable linear polynomials based on measured slip slope and corresponding road surface types.

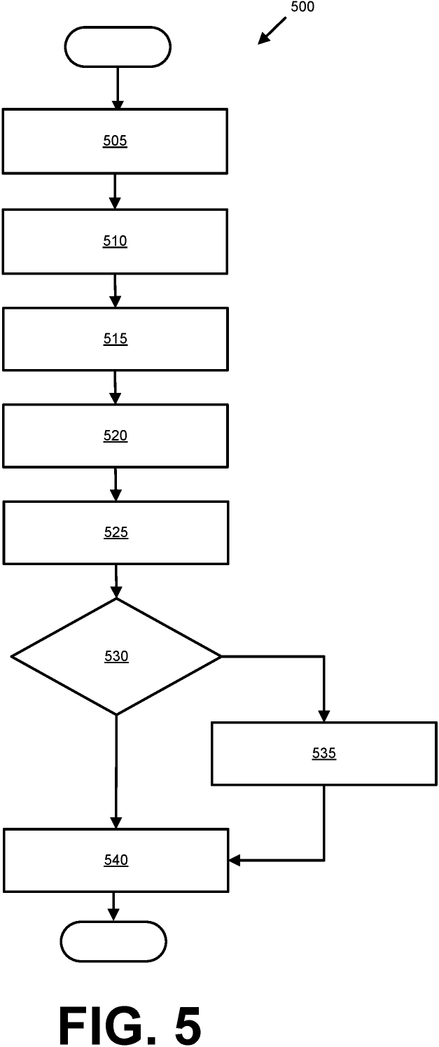

FIG. 5 illustrates an example process 500 for estimating a target slip and controlling one or more vehicle components 125 based on the estimated target slip. Blocks of the process 500 can be executed by the computer 110. At block 505, sensor data is received from one or more vehicle sensors 115. For example, the sensor data can comprise one or more tire force measures, such as wheel velocity associated with a rear axle of the vehicle 105. At block 510, the observer module 225 estimates a slip slope based on acceleration values. The acceleration values can be derived by the computer 110 using the sensor data. At block 515, the observer module 225 predicts the road texture. The observer module 225 can predict the road texture using the slip ratio and/or the measured tire forces as discussed above.

At block 520, the trained machine learning classifier 235 receives input data from the sensors 115 and/or the observer module 225. For example, the trained machine learning classifier 235 can receive the predicted slip slope and the predicted road texture from the observer module 225. The trained machine learning classifier 235 can also receive the slip ratio and/or the tire force measurements from the sensors 115. At block 525, the trained machine learning classifier 235 generates a prediction representing the target slip value based on the received input.

At block 530, a determination is made whether the confidence level value for the target slip value is less than a confidence level threshold. At block 535, the linear interpolation module 230 predicts the target slip value based on the predicted slip slope and the predicted road texture when the confidence level value is less than a confidence level threshold. If the confidence level value is greater than or equal to the confidence level threshold, the process 500 transitions to block 540.

At block 540, the predicted target slip value is provided to the vehicle actuators 120 and/or vehicle components 125, such as the anti-lock braking system component (ABS), the traction control system component (TCS), and/or the electronic stability control system component. The predicted target slip value can be used by the vehicle components 125 to modify one or more vehicle 105 actions. For example, the components 125 can be configured to modify one or more vehicle 105 actions to maximize tire grip. The process 500 then ends.

The description of the present disclosure is merely exemplary in nature and variations that do not depart from the gist of the present disclosure are intended to be within the scope of the present disclosure. Such variations are not to be regarded as a departure from the spirit and scope of the present disclosure.

In general, the computing systems and/or devices described may employ any of a number of computer operating systems, including, but by no means limited to, versions and/or varieties of the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer readable medium (also referred to as a processor readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain implementations, and should in no way be construed so as to limit the claims.

Accordingly, it is to be understood that the above description is intended to be illustrative and not restrictive. Many implementations and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future implementations. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising a computer including a processor and a memory, the memory including instructions such that the processor is programmed to:
predict, at a trained machine learning classifier, a target slip value based on a predicted slip slope and a predicted road texture, wherein the predicted slip slope and the predicted road texture are determined using sensor data representing tire forces; and
modify at least one vehicle action based on the target slip value when a confidence level value corresponding to the target slip value is greater than or equal to a confidence level threshold.

2. The system of claim 1, wherein the processor is further programmed to determine the target slip value via interpolation modeling when the confidence level value is less than the confidence level threshold.

3. The system of claim 2, wherein the interpolation modeling comprises linear interpolation modeling.

4. The system of claim 1, wherein the processor is further programmed to receive the sensor data representing the tire forces.

5. The system of claim 1, wherein the tire forces comprise measurements representing a wheel velocity of a vehicle.

6. The system of claim 1, wherein the trained machine learning classifier comprises a Gaussian Process Classifier.

7. The system of claim 1, wherein the processor is further programmed to modify at least one of anti-lock braking system, a traction control system, or an electronic stability control system based on the target slip value.

8. The system of claim 1, wherein the processor is further programmed to determine the predicted road texture based on at least one of a slip ratio or the tire forces.

9. The system of claim 8, wherein the processor is further programmed to access a lookup table that relates road texture to the at least one of the slip ratio or the tire forces.

10. The system of claim 1, wherein the trained machine learning classifier generates the confidence level value.

11. A method comprising:
predicting, at a trained machine learning classifier, a target slip value based on a predicted slip slope and a predicted road texture, wherein the predicted slip slope and the predicted road texture are determined using sensor data representing tire forces; and
modifying at least one vehicle action based on the target slip value when a confidence level value corresponding to the target slip value is greater than or equal to a confidence level threshold.

12. The method of claim 11, the method further comprising determining the target slip value via interpolation modeling when the confidence level value is less than the confidence level threshold.

13. The method of claim 12, wherein the interpolation modeling comprises linear interpolation modeling.

14. The method of claim 11, the method further comprising receiving the sensor data representing the tire forces.

15. The method of claim 11, wherein the tire forces comprise measurements representing a wheel velocity of a vehicle.

16. The method of claim 11, wherein the trained machine learning classifier comprises a Gaussian Process Classifier.

17. The method of claim 16, the method further comprising modifying at least one of anti-lock braking system, a traction control system, or an electronic stability control system based on the target slip value.

18. The method of claim 11, the method further comprising determining the predicted road texture based on at least one of a slip ratio or the tire forces.

19. The method of claim 11, the method further comprising accessing a lookup table that relates road texture to the at least one of the slip ratio or the tire forces.

20. The method of claim 11, wherein the trained machine learning classifier generates the confidence level value.
